(19) United States
(12) Patent Application Publication
(10) Pub. No.: US 2013/0293288 A1
(43) Pub. Date: Nov. 7, 2013

(54) CHIP CONTROL METHOD AND DEVICE

(71) Applicant: Huawei Technologies Co., Ltd., (US)

(72) Inventors: Jianfeng Yu, Shanghai (CN); Chunlei Sun, Shanghai (CN)

(21) Appl. No.: 13/886,612

(22) Filed: May 3, 2013

(30) Foreign Application Priority Data
May 4, 2012 (CN) 201210137167.3

(51) Int. Cl. G05F 1/46

(52) U.S. Cl. CPC G05F 1/46
USPC 327/538

(57) ABSTRACT

A chip control method, The method includes: acquiring a required frequency of the chip; detecting a current temperature of the chip, and determining a temperature range [Tₘ, Tₘ₊₁] to which the current temperature belongs, where T indicates a temperature, and m is a natural number; determining, through comparison according to ascending order of sorting the n voltage ranks, whether a frequency at which the chip can work at each temperature point of an analytical temperature range in an i^{th} voltage rank is higher than the required frequency, where the analytical temperature range has a margin δ relative to the temperature range [Tₘ, Tₘ₊₁], δ≧0, and i=0, 1, . . . , n−1; and if yes, using the i^{th} voltage rank as a working voltage of the chip, and using the required frequency as a working frequency of the chip.

### CROSS-REFERENCE TO RELATED APPLICATIONS

This application claims priority to Chinese Patent Application No. 201210137167.3, filed on May 4, 2012, which is hereby incorporated by reference in its entirety.

### TECHNICAL FIELD

The present invention relates to the chip field, and in particular to a chip control method and device.

### BACKGROUND

A chip generally refers to a silicon slice that includes an application specific integrated circuit (Application Specific Integrated Circuit, ASIC). A volume of the chip is usually extremely small, and the chip is often used as a part of a computer or another device. In a design process of a chip, power consumption of the chip is a technical problem about which a chip designer is greatly concerned. How to reduce a working voltage of a chip as much as possible on a precondition of satisfying chip performance so as to achieve an objective of reducing power consumption of the chip is a hot issue for all chip designers to research.

### SUMMARY

A chip control method and device according to embodiments of the present invention can reduce a working voltage of a chip as much as possible on a precondition of satisfying chip performance.

One aspect of the embodiments of the present invention provides a chip control method, where the chip provides n voltage ranks, n is a natural number larger than or equal to 2, a working temperature of the chip is divided into at least two temperature ranges, and the method includes:

acquiring a required frequency of the chip;

detecting a current temperature of the chip, and determining a temperature range [Tₘ, Tₘ₊₁] to which the current temperature belongs, where T indicates a temperature, and m is a natural number;

determining, through comparison according to ascending order of sorting the n voltage ranks, whether a frequency at which the chip can work at each temperature point of an analytical temperature range in an i^{th} voltage rank is higher than the required frequency, where the analytical temperature range has a margin δ relative to the temperature range [Tₘ, Tₘ₊₁], δ≧0, and i=0, 1, . . . , n−1; and
if yes, using the i^{th} voltage rank as a working voltage of the chip, and using the required frequency as a working frequency of the chip.

Another aspect of the embodiments of the present invention provides a chip control device, where a chip that is controlled by the chip control device provides n voltage ranks, n is a natural number larger than or equal to 2, a working temperature of the chip is divided into at least two temperature ranges, and the chip control device includes:

an acquiring unit, configured to acquire a required frequency of the chip;

a detecting unit, configured to detect a current temperature of the chip, and determine a temperature range [Tₘ, Tₘ₊₁] to which the current temperature belongs, where T indicates a temperature, and m is a natural number;

a comparing unit, configured to determine, through comparison according to ascending order of sorting the n voltage ranks, whether a frequency at which the chip can work at each temperature point of an analytical temperature range in an i^{th} voltage rank is higher than the required frequency, where the analytical temperature range has a margin δ relative to the temperature range [Tₘ, Tₘ₊₁], δ≧0, and i=0, 1, . . . , n−1; and
an updating unit, configured to use the i^{th} voltage rank as a working voltage of the chip and use the required frequency as a working frequency of the chip when a comparison result of the comparing unit is yes.

Another aspect of the embodiments of the present invention further provides a chip, where the chip includes the foregoing chip control device.

In the embodiments of the present invention, when a required frequency of a chip is acquired, a temperature range to which a current temperature of the chip belongs is first determined; then it is determined, through comparison according to ascending order of sorting n voltage ranks that are provided by the chip, whether a frequency at which the chip can work at each temperature point of an analytical temperature range in an i^{th} (i=0, 1, . . . , n−1) voltage rank is lower than the required frequency, where the analytical temperature range has a margin δ relative to the temperature range; and, if yes, the i^{th} voltage rank is used as a working voltage of the chip and the required frequency is used as a working frequency of the chip. It can be seen that, in the embodiments of the present invention, an impact of a temperature on a working voltage and a working frequency of a chip is taken into consideration, and the working voltage and the working frequency of the chip are updated according to temperature detection, so that the working voltage of the chip is reduced as much as possible on a precondition of satisfying chip performance, thereby effectively reducing power consumption of the chip.

### BRIEF DESCRIPTION OF DRAWINGS

To describe the technical solutions in the embodiments of the present invention more clearly, the following briefly introduces accompanying drawings required for describing the embodiments. Apparently, the accompanying drawings in the following description are merely some embodiments of the present invention, and persons of ordinary skill in the art may further obtain other drawings according to these accompanying drawings without creative efforts.

FIG. 1 is a flowchart of a chip control method according to an embodiment of the present invention;

FIG. 2 is a flowchart of another chip control method according to an embodiment of the present invention;

FIG. 3. is a schematic diagram of a relationship among a temperature, a voltage, and a frequency of a chip according to an embodiment of the present invention;

FIG. 4 is a flowchart of another chip control method according to an embodiment of the present invention;

FIG. 5 is a flowchart of another chip control method according to an embodiment of the present invention; and

FIG. 6 is a structural diagram of a chip control device according to an embodiment of the present invention.

### DESCRIPTION OF EMBODIMENTS

The following clearly describes the technical solutions in the embodiments of the present invention with reference to the accompanying drawings in the embodiments of the present invention. Apparently, the embodiments to be described are merely part rather than all of the embodiments of the present invention. All other embodiments obtained by persons of ordinary skill in the art based on the embodiments of the present invention without creative efforts shall fall within the protection scope of the present invention.

A chip control method and device according to the embodiments of the present invention can reduce a working voltage of a chip as much as possible on a precondition of satisfying chip performance, thereby effectively reducing power consumption of the chip. Detailed description is given in the following.

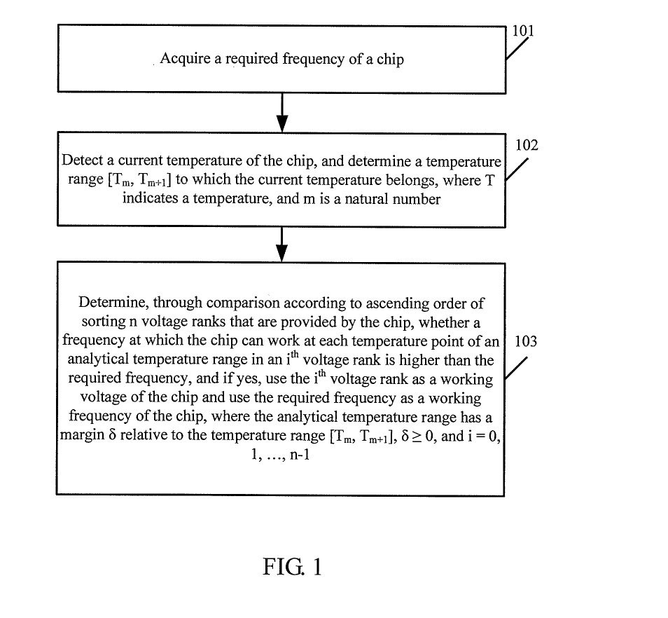

Refer to FIG. 1. FIG. 1 is a flowchart of a chip control method according to an embodiment of the present invention. In the chip control method shown in FIG. 1, a chip may provide n voltage ranks, where n is a natural number larger than or equal to 2, and a working temperature of the chip is divided into at least two temperature ranges. As shown in FIG. 1, the chip control method may include the following steps:

101: Acquire a required frequency of the chip.

In this embodiment of the present invention, a reason for acquiring the required frequency of the chip is generally that a load of the chip is excessively high or excessively low. For example, when the load of the chip is excessively high, generally a frequency of the chip needs to be raised, so as to adapt to the load of the chip; and when the load of the chip is excessively low, generally a frequency of the chip needs to be reduced, so as to adapt to the load of the chip. That is to say, the required frequency of the chip needs to be acquired when the load of the chip is either excessively high or excessively low. It can be seen that, the required frequency is a working frequency that is required to adapt to a change of the load of the chip.

In an embodiment, the required frequency of the chip may be internally generated by the chip, and accordingly the required frequency that is internally generated by the chip may be acquired. In another embodiment, the required frequency of the chip may also be generated by an external device, and accordingly the required frequency that is input by a pin of the chip may be acquired.

In this embodiment of the present invention, a generating manner of the required frequency of the chip may determine a triggering manner of chip control. For example, when the required frequency of the chip is internally generated by the chip, the triggering manner of chip control may be automatic triggering by the chip; and when the required frequency of the chip is generated by an external device, the triggering manner of chip control may be triggering by the external device.

102: Detect a current temperature of the chip, and determine a temperature range [Tₘ, Tₘ₊₁] to which the current temperature belongs, where T indicates a temperature, and m is a natural number.

In an embodiment, a temperature sensor may be embedded in the chip. When the required frequency of the chip is acquired, starting of the temperature sensor may be triggered, and the temperature sensor has detected the current temperature of the chip, so as to further determine the temperature range [Tₘ, Tₘ₊₁] to which the current temperature belongs.

103: Determine, through comparison according to ascending order of sorting the n voltage ranks that are provided by the chip, whether a frequency at which the chip can work at each temperature point of an analytical temperature range in an i^{th} voltage rank is higher than the required frequency, and if yes, use the i^{th} voltage rank as a working voltage of the chip and use the required frequency as a working frequency of the chip, where the analytical temperature range has a margin δ relative to the temperature range [Tₘ, Tₘ₊₁], δ≧0, and i=0, 1, . . . , n−1.

As described above, there is a margin δ between the analytical temperature range and the temperature range [Tₘ, Tₘ₊₁]. Therefore, for example, an expression form of the analytical temperature range may be [Tₘ−δ, Tₘ₊₁+δ]. In this embodiment of the present invention, δ may be mathematically regarded as an infinitesimal number. Its value may specifically be set according to a requirement of preventing a system from repeatedly adjusting a voltage when a temperature changes around an endpoint of the temperature range. During practical problem resolution, it is highly probable that some smaller values need to be selected to replace the infinitesimal number. Therefore, a specific value is probably not a mathematically infinitesimal number, for example, δ may be 0.1, 0.001, and the like.

In this embodiment of the present invention, the frequency at which the chip can work at each temperature point of the analytical temperature range in the i^{th} voltage rank may be obtained through a time sequence analysis performed on chip logic, which is not specifically limited in this embodiment of the present invention.

In an embodiment, if it is determined through comparison that the frequency at which the chip can work at each temperature point of the analytical temperature range in the i^{th} voltage rank is lower than the required frequency, it may be further determined, through comparison, whether a frequency at which the chip can work at each temperature point of the analytical temperature range in an (i₊₁)^{th} voltage rank is higher than the required frequency.

In an embodiment, if all frequencies at which the chip can work at each temperature point of the analytical temperature range (such as [Tₘ−δ, Tₘ₊₁+δ]) in the n voltage ranks are lower than the required frequency, in the chip control method, a highest voltage rank among the n voltage ranks that are provided by the chip is used as a working voltage of the chip, and a frequency at which the chip can work at each temperature point of the analytical temperature range (such as [Tₘ−δ, Tₘ₊₁+δ]) in the highest voltage rank is used as a working frequency of the chip, thereby ensuring that, when the chip cannot adapt to the required frequency in some harsh scenarios, the highest voltage rank in which the chip can work at the current temperature may be provided as much as possible and the frequency at which the chip can work at each temperature point of the analytical temperature range (such as [Tₘ−δ, Tₘ₊₁+δ]) in the highest voltage rank is used as the working frequency of the chip, so as to ensure that an error does not occur to a function of the chip.

In an embodiment, in the chip control method shown in FIG. 1, it may be further detected whether the current temperature of the chip rises to another temperature range [Tₘ₊₁, Tₘ₊₂]; if yes, it is determined, through comparison according to the ascending order of sorting the n voltage ranks that are provided by the chip, whether a frequency at which the chip can work at each temperature point of another analytical temperature range in the i^{th} voltage rank is higher than the required frequency; and if yes, the i^{th} voltage rank is used as the working voltage of the chip and the required frequency is used as the working frequency of the chip, where the another analytical temperature range also has a margin δ relative to the another temperature range [Tₘ₊₁, Tₘ₊₂], for example, an expression form of the another analytical temperature range may be [Tₘ₊₁−δ, Tₘ₊₂+δ]. On the contrary, if all frequencies at which the chip can work at each temperature point of the another analytical temperature range (such as [Tₘ₊₁−δ, Tₘ₊₂+δ]) in the n voltage ranks are lower than the required frequency, in the chip control method, the highest voltage rank among the n voltage ranks that are provided by the chip may also be used as the working voltage of the chip, and a frequency at which the chip can work at each temperature point of the another analytical temperature range (such as [Tₘ₊₁−δ, Tₘ₊₂+δ]) in the highest voltage rank is used as the working frequency of the chip, so as to ensure that an error does not occur to a function of the chip.

In an embodiment, in the chip control method shown in FIG. 1, it may be further detected whether the current temperature of the chip exceeds Tₘ₊₁+δ in [Tₘ−δ, Tₘ₊₁+δ]. If the current temperature of the chip exceeds Tₘ₊₁+δ in [Tₘ−δ, Tₘ₊₁+δ], it indicates that the current temperature of the chip has risen from [Tₘ,Tₘ₊₁] to another temperature range [Tₘ₊₁, Tₘ₊₂]; on the contrary, it indicates that the current temperature of the chip does not rise to another temperature range [Tₘ₊₁, Tₘ₊₂] yet.

In an embodiment, in the chip control method shown in FIG. 1, it may be further detected whether the current temperature of the chip drops to another temperature range [Tₘ₋₁, Tₘ]; if yes, it is determined, through comparison according to the ascending order of sorting the n voltage ranks that are provided by the chip, whether a frequency at which the chip can work at each temperature point of another analytical temperature range in the i^{th} voltage rank is higher than the required frequency; and, if yes, the i^{th} voltage rank is used as the working voltage of the chip and the required frequency is used as the working frequency of the chip, where the another analytical temperature range also has a margin δ relative to the another temperature range [Tₘ₋₁, Tₘ], for example, an expression form of the another analytical temperature range may be [Tₘ₋₁−δ, Tₘ+δ]. On the contrary, if all frequencies at which the chip can work at each temperature point of the another analytical temperature range (such as [Tₘ₋₁−δ, Tₘ+δ]) in the n voltage ranks are lower than the required frequency, in the chip control method, the highest voltage rank among the n voltage ranks that are provided by the chip may also be used as the working voltage of the chip, and a frequency at which the chip can work at each temperature point of the another analytical temperature range (such as [Tₘ₋₁−δ, Tₘ+δ]) in the highest voltage rank is used as the working frequency of the chip, so as to ensure that an error does not occur to a function of the chip.

In an embodiment, in the chip control method shown in FIG. 1, it may be further detected whether the current temperature of the chip is lower than Tₘ₊₁+δ in [Tₘ−δ, Tₘ₊₁+δ]. If the current temperature of the chip is lower than [Tₘ₋₁−δ, Tₘ+δ], it indicates that the current temperature of the chip has dropped from [Tₘ, Tₘ₊₁] to another temperature range [Tₘ₋₁, Tₘ]; on the contrary, it indicates that the current temperature of the chip does not drop to another temperature range [Tₘ₋₁, Tₘ] yet.

In the chip control method shown in FIG. 1, an impact of a temperature on a working voltage and a working frequency of a chip is taken into consideration, and the working voltage and the working frequency of the chip may be updated according to temperature detection, so that the working voltage of the chip is reduced as much as possible on a precondition of satisfying chip performance, thereby effectively reducing power consumption of the chip.

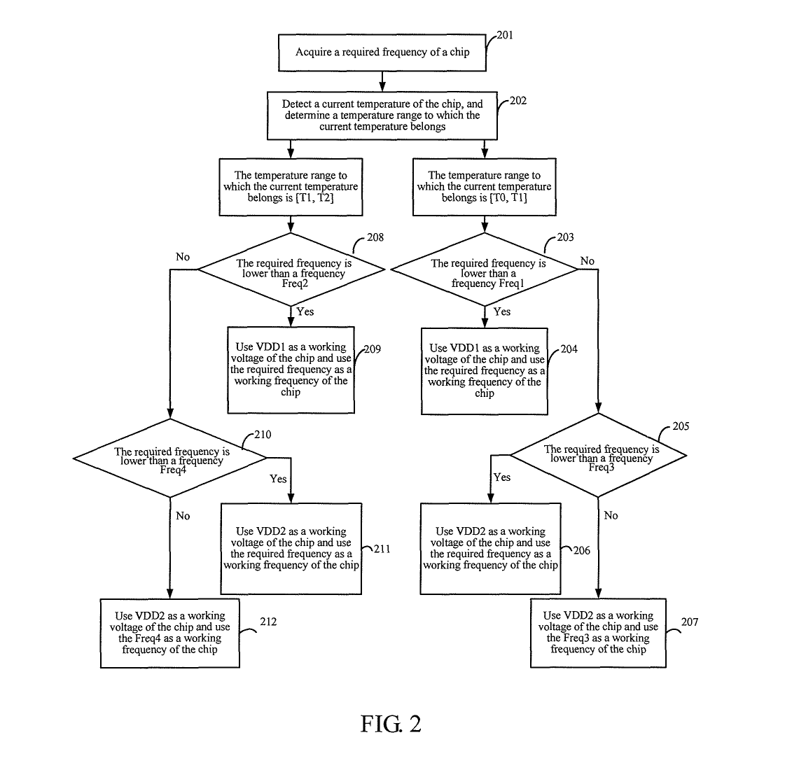

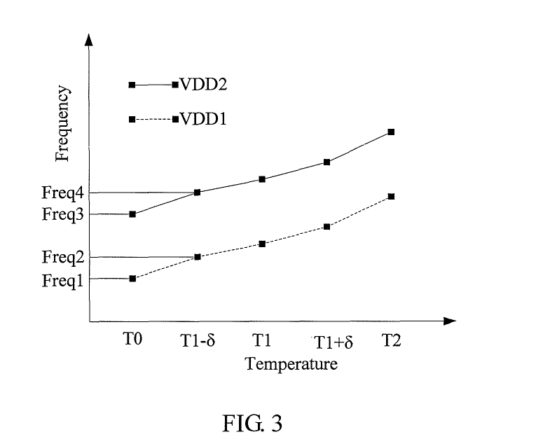

Refer to FIG. 2. FIG. 2 is a flowchart of another chip control method according to an embodiment of the present invention. In the chip control method shown in FIG. 2, it is assumed that a chip may provide two voltage ranks, VDD1 and VDD2, where VDD1<VDD2, and a working temperature of the chip is divided into two temperature ranges [T0, T1] and [T1, T2]. Further, it is assumed that, in VDD1, a frequency at which the chip can work at each temperature point within [T0, T1] is Freq1, while a frequency at which the chip can work at each temperature point within [T1, T2] is Freq2; and it is assumed that, in VDD2, a frequency at which the chip can work at each temperature point within [T0, T1] is Freq3, while a frequency at which the chip can work at each temperature point within [T1, T2] is Freq4; or, in a schematic diagram of a relationship among a temperature, a voltage, and a frequency of a chip shown in FIG. 3, it is assumed that, in VDD1, a frequency at which the chip can work at each temperature point within [T0, T1+δ] is Freq1, while a frequency at which the chip can work at each temperature point within [T1−δ, T2] is Freq2; and it is assumed that, in VDD2, a frequency at which the chip can work at each temperature point within [T0, T1+δ] is Freq3, while a frequency at which the chip can work at each temperature point within [T1−δ, T2] is Freq4, where a major purpose of designing 5 is to avoid repeated adjustment of a working voltage of the chip when a temperature of the chip changes around a demarcation point T1 of a temperature range. In the chip control method shown in FIG. 2, taking the former definitions of Freq1 to Freq3 as an example, the chip control method may include the following steps:

201: Acquire a required frequency of the chip.

202: Detect a current temperature of the chip. If a temperature range to which the current temperature belongs is [T0, T1], execute step 203; and if the temperature range to which the current temperature belongs is [T1, T2], execute step 208.

203: Determine, through comparison, whether the frequency Freq1 at which the chip can work at each temperature point of [T0, T1] in VDD1 is higher than the required frequency. If yes, execute step 204; and if no, execute step 205.

204: Use VDD1 as a working voltage of the chip, use the required frequency as a working frequency of the chip, and end this flow.

205: Determine, through comparison, whether the frequency Freq3 at which the chip can work at each temperature point of [T0, T1] in VDD2 is higher than the required frequency. If yes, execute step 206; and if no, execute step 207.

206: Use VDD2 as a working voltage of the chip, use the required frequency as a working frequency of the chip, and end this flow.

207: Use VDD2 as a working voltage of the chip, use the frequency Freq3 at which the chip can work at each temperature point of [T0, T1] in VDD2 as a working frequency of the chip, and end this flow.

208: Determine, through comparison, whether the frequency Freq2 at which the chip can work at each temperature point of [T1, T2] in VDD1 is higher than the required frequency. If yes, execute step 209; and if no, execute step 210.

209: Use VDD1 as a working voltage of the chip, use the required frequency as a working frequency of the chip, and end this flow.

210: Determine, through comparison, whether the frequency Freq4 at which the chip can work at each temperature point of [T1, T2] in VDD2 is higher than the required frequency. If yes, execute step 211; and if no, execute step 212.

211: Use VDD2 as a working voltage of the chip, use the required frequency as a working frequency of the chip, and end this flow.

212: Use VDD2 as a working voltage of the chip, use the frequency Freq4 at which the chip can work at each temperature point of [T1, T2] in VDD2 as a working frequency of the chip, and end this flow.

In the chip control method shown in FIG. 2, an impact of a temperature on a working voltage and a working frequency of a chip is taken into consideration, and the working voltage and the working frequency of the chip may be updated according to temperature detection, so that the working voltage of the chip is reduced as much as possible on a precondition of satisfying chip performance, thereby effectively reducing power consumption of the chip.

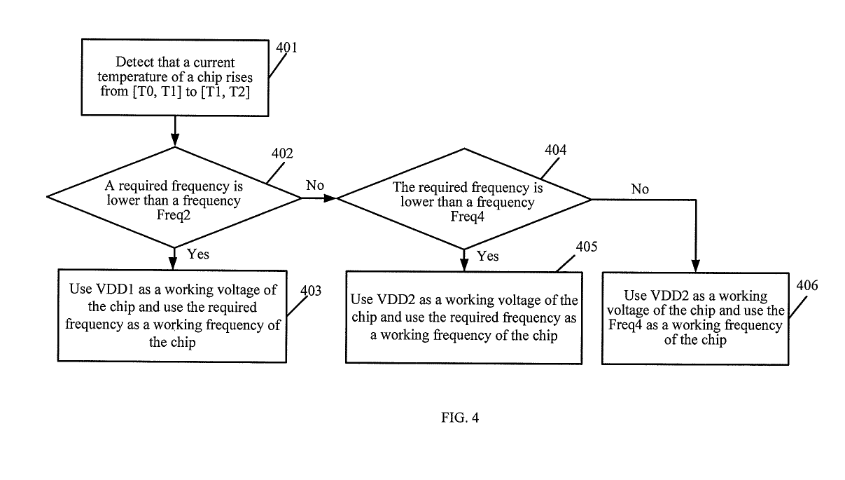

In the chip control method according to this embodiment of the present invention, when the temperature of the chip during working rises to another temperature range, the working voltage and the working frequency of the chip need to be adjusted in time, so as to reduce power consumption of the chip. For example, when the temperature range to which the current temperature of the chip belongs is [T0, T1], and when a temperature sensor has detected that the current temperature of the chip rises to [T1, T2], the working voltage and the working frequency of the chip need to be adjusted in time. When the temperature of the chip during working rises to the another temperature range, a flow of adjusting the working voltage and the working frequency of the chip is shown in FIG. 4, where the flow includes the following steps:

401: Detect that the current temperature of the chip rises from [T0, T1] to [T1, T2], and execute step 402.

402: Determine, through comparison, whether the frequency Freq2 at which the chip can work at each temperature point of [T1, T2] in VDD1 is higher than the required frequency. If yes, execute step 403; and if no, execute step 404.

403: Use VDD1 as the working voltage of the chip, use the required frequency as the working frequency of the chip, and end this flow.

404: Determine, through comparison, whether the frequency Freq4 at which the chip can work at each temperature point of [T1, T2] in VDD2 is higher than the required frequency. If yes, execute step 405; and if no, execute step 406.

405: Use VDD2 as the working voltage of the chip, use the required frequency as the working frequency of the chip, and end this flow.

406: Use VDD2 as the working voltage of the chip, use the frequency Freq4 at which the chip can work at each temperature point of [T1, T2] in VDD2 as the working frequency of the chip, and end this flow.

In the method shown in FIG. 4, when the temperature of the chip rises to another temperature range, the working voltage and the working frequency of the chip are re-adjusted, so that the working voltage and the working frequency of the chip achieve better matching on a precondition of satisfying chip performance as much as possible, to reduce the working voltage of the chip as much as possible, thereby reducing power consumption of the chip.

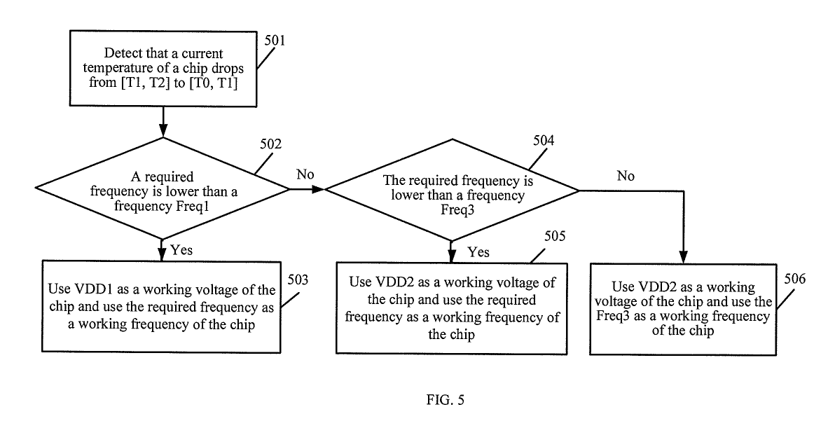

In the chip control method according to this embodiment of the present invention, when the temperature of the chip during working drops to another temperature range, the working voltage and the working frequency of the chip need to be adjusted in time, so as to reduce power consumption of the chip. For example, when the temperature range to which the current temperature of the chip belongs is [T1, T2] and when a temperature sensor has detected that the current temperature of the chip drops to [T0, T1], the working voltage and the working frequency of the chip need to be adjusted in time. When the temperature of the chip during working drops to the another temperature range, a flow of adjusting the working voltage and the working frequency of the chip is shown in FIG. 5, where the flow includes the following steps:

501: Detect that the current temperature of the chip drops from [T1, T2] to [T0, T1], and execute step 502.

502: Determine, through comparison, whether the frequency Freq1 at which the chip can work at each temperature point of [T0, T1] in VDD1 is higher than the required frequency. If yes, execute step 503; and if no, execute step 504.

503: Use VDD1 as the working voltage of the chip, use the required frequency as the working frequency of the chip, and end this flow.

504: Determine, through comparison, whether the frequency Freq3 at which the chip can work at each temperature point of [T0, T1] in VDD2 is higher than the required frequency. If yes, execute step 505; and if no, execute step 506.

505: Use VDD2 as the working voltage of the chip, use the required frequency as the working frequency of the chip, and end this flow.

506: Use VDD2 as the working voltage of the chip, use the frequency Freq3 at which the chip can work at each temperature point of [T0, T1] in VDD2 as the working frequency of the chip, and end this flow.

In the method shown in FIG. 5, when the temperature of the chip drops to the another temperature range, the working voltage and the working frequency of the chip are re-adjusted, so that the working voltage and the working frequency of the chip achieve better matching on a precondition of satisfying chip performance as much as possible, to reduce the working voltage of the chip as much as possible, thereby reducing power consumption of the chip.

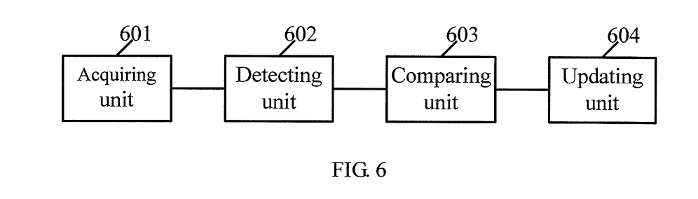

Refer to FIG. 6. FIG. 6 is a structural diagram of a chip control device according to an embodiment of the present invention. A chip that is controlled by the chip control device shown in FIG. 6 may provide n voltage ranks, where n is a natural number larger than or equal to 2, and a working temperature of the chip is divided into at least two temperature ranges. As shown in FIG. 6, the chip control device may include an acquiring unit 601, a detecting unit 602, a comparing unit 603, and an updating unit 604, where:

the acquiring unit 601 is configured to acquire a required frequency of the chip; the detecting unit 602 is configured to detect a current temperature of the chip, and determine a temperature range [Tₘ, Tₘ₊₁] to which the current temperature belongs, where T indicates a temperature, and m is a natural number; the comparing unit 603 is configured to determine, through comparison according to ascending order of sorting the n voltage ranks, whether a frequency at which the chip can work at each temperature point of an analytical temperature range in an i^{th} voltage rank is higher than the required frequency, where the analytical temperature range has a margin δ relative to the temperature range [Tₘ, Tₘ₊₁], and δ≧0; and the updating unit 604 is configured to use the i^{th} voltage rank as a working voltage of the chip and use the required frequency as a working frequency of the chip when a comparison result of the comparing unit 603 is yes.

In an embodiment, if the comparing unit 603 determines, through comparison, that the frequency at which the chip can work at each temperature point of the analytical temperature range (such as [Tₘ−δ, Tₘ₊₁+δ]) in the i^{th} voltage rank is lower than the required frequency, the comparing unit 603 may further determine, through comparison, whether a frequency at which the chip can work at each temperature point of the analytical temperature range in an (i₊1) ^{th} voltage rank is higher than the required frequency.

In an embodiment, if the comparing unit 603 determines, through comparison, that all frequencies at which the chip can work at each temperature point of the analytical temperature range (such as [Tₘ−δ, Tₘ₊₁+δ]) in the n voltage ranks are lower than the required frequency, the updating unit 604 is further configured to use a highest voltage rank among the n voltage ranks as a working voltage of the chip, and use a frequency at which the chip can work at each temperature point of the analytical temperature range (such as [Tₘ−δ, Tₘ₊₁+δ]) in the highest voltage rank as a working frequency of the chip, thereby ensuring that, when the chip cannot adapt to the required frequency in some harsh scenarios, the highest voltage rank in which the chip can work at the current temperature may be provided as much as possible and the frequency at which the chip can work at each temperature point of the analytical temperature range (such as [Tₘ−δ, Tₘ₊₁+δ]) in the highest voltage rank is used as the working frequency of the chip, so as to ensure that an error does not occur to a function of the chip.

In an embodiment, the detecting unit 602 is further configured to detect whether the current temperature of the chip rises to another temperature range [Tₘ₊₁, Tₘ₊₂]; accordingly, the comparing unit 603 is further configured to, when the detecting unit 602 has detected that the current temperature of the chip rises to the another temperature range [Tₘ₊₁, Tₘ₊₂], determine, through comparison according to the ascending order of sorting the n voltage ranks, whether a frequency at which the chip can work at each temperature point of another analytical temperature range in the i^{th} voltage rank is higher than the required frequency, where the another analytical temperature range also has a margin δ relative to the another temperature range [Tₘ₊₁, Tₘ₊₂]; and the updating unit 604 is further configured to use the i^{th} voltage rank as the working voltage of the chip and use the required frequency as the working frequency of the chip when the comparing unit 603 determines, through comparison, that the frequency at which the chip can work at each temperature point of the another analytical temperature range (such as [Tₘ₊₁−δ, Tₘ₊₂+δ]) in the i^{th} voltage rank is higher than the required frequency. On the contrary, if the comparing unit 603 determines, through comparison, that all frequencies at which the chip can work at each temperature point of the another analytical temperature range (such as [Tₘ₊₁−δ, Tₘ₊₂+δ]) in the n voltage ranks are lower than the required frequency, the updating unit 604 is further configured to use the highest voltage rank among the n voltage ranks as the working voltage of the chip, and use a frequency at which the chip can work at each temperature point of the another analytical temperature range (such as [Tₘ₊₁−δ, Tₘ₊₂+δ] in the highest voltage rank as the working frequency of the chip.

In an embodiment, in the chip control device shown in FIG. 6 the detecting unit 602 may detect whether the current temperature of the chip exceeds [Tₘ−δ, Tₘ₊₁+δ]. If the current temperature of the chip exceeds [Tₘ−δ, Tₘ₊₁+δ], it indicates that the current temperature of the chip has risen from [Tₘ, Tₘ₊₁] to another temperature range [Tₘ₊₁, Tₘ₊₂]; on the contrary, it indicates that the current temperature of the chip does not rise to another temperature range [Tₘ₊₁, Tₘ₊₂] yet.

In an embodiment, the detecting unit 602 is further configured to detect whether the current temperature of the chip drops to another temperature range [Tₘ₋₁, Tₘ]; accordingly, the comparing unit 603 is further configured to, when the detecting unit 602 has detected that the current temperature of the chip drops to the another temperature range [Tₘ₋₁, Tₘ], determine, through comparison according to the ascending order of sorting the n voltage ranks, whether a frequency at which the chip can work at each temperature point of another analytical temperature range in the i^{th} voltage rank is higher than the required frequency, where the another analytical temperature range also has a margin δ relative to the another temperature range [Tₘ₋₁, Tₘ]; and the updating unit 604 is further configured to use the i^{th} voltage rank as the working voltage of the chip and use the required frequency as the working frequency of the chip when the comparing unit 603 determines, through comparison, that the frequency at which the chip can work at each temperature point of the another analytical temperature range (such as [Tₘ₋₁−δ, Tₘ+δ]) in the i^{th} voltage rank is higher than the required frequency. On the contrary, if the comparing unit 603 determines, through comparison, that all frequencies at which the chip can work at each temperature point of the another analytical temperature range (such as [Tₘ₋₁−δ, Tₘ+δ]) in the n voltage ranks are lower than the required frequency, the updating unit 604 is further configured to use the highest voltage rank among the n voltage ranks as the working voltage of the chip, and use a frequency at which the chip can work at each temperature point of the another analytical temperature range (such as [Tₘ₋₁−δ, Tₘ+δ]) in the highest voltage rank as the working frequency of the chip.

In an embodiment, in the chip control device shown in FIG. 6, the detecting unit 602 [Tₘ₋₁−δ, Tₘ+δ]. If the current temperature of the chip is lower than [Tₘ₋₁−δ, Tₘ+δ], it indicates that the current temperature of the chip has dropped from [Tₘ, Tₘ₊₁] to another temperature range [Tₘ₋₁, Tₘ]; on the contrary, it indicates that the current temperature of the chip does not drop to another temperature range [Tₘ₋₁, Tₘ] yet.

In an embodiment, the acquiring unit 601 is specifically configured to acquire a required frequency that is internally generated by the chip, or configured to acquire a required frequency that is input by a pin of the chip, which is not limited in this embodiment of the present invention.

In the chip control device according to this embodiment of the present invention, an impact of a temperature on a working voltage and a working frequency of a chip is taken into consideration, and the working voltage and the working frequency of the chip are updated according to temperature detection, so that the working voltage of the chip is reduced as much as possible on a precondition of satisfying chip performance, thereby effectively reducing power consumption of the chip.

The chip control device according to this embodiment of the present invention may be built in a chip, so that a working voltage of the chip is reduced as much as possible on a precondition of satisfying chip performance, thereby effectively reducing power consumption of the chip.

In the chip control method and device according to the embodiments of the present invention, an impact of a temperature on a working voltage and a working frequency of a chip is taken into consideration. The working voltage is adjusted according to a current working temperature of the chip when the working frequency of the chip is adjusted. In addition, when a temperature of the chip changes, re-adjusting the working frequency and the working voltage of the chip is also taken into consideration, so that the working voltage and the working frequency of the chip achieve better matching on a precondition of satisfying a chip performance requirement as much as possible, thereby reducing the working voltage of the chip as much as possible and reducing power consumption of the chip. At the same time, it is also ensured that, when the chip cannot adapt to a required frequency in some harsh scenarios, the chip is capable of providing a highest voltage rank in which the chip can work at a current temperature as much as possible, and a frequency at which the chip can work at each temperature point of the temperature range in the highest voltage rank is used as the working frequency of the chip, thereby ensuring that an error does not occur to a function of the chip.

In the embodiments of the present invention, more voltage ranks may be provided for a chip, so that a voltage-frequency adjustment is achieved at finer granularity. In the embodiments of the present invention, a working temperature of a chip may be divided into more ranges, so that in a current working frequency, a working voltage as low as possible may be provided through sub-dividing a temperature.

Persons of ordinary skill in the art may understand that all or part of the steps of the methods in the foregoing embodiments may be implemented by a program instructing relevant hardware. The program may be stored in a computer readable storage medium, and the storage medium may include: a flash drive, a read-only memory (Read-Only Memory, ROM) , a random access memory (Random Access Memory, RAM), a magnetic disk, or an optical disk, or the like.

A chip control method and device provided in the embodiments of the present invention are described in detail in the foregoing. Specific cases are used for describing principles and embodiments of the present invention. The foregoing description about the embodiments is merely used to help understand the methods and core ideas of the present invention. Meanwhile, persons skilled in the art may make modifications to the specific implementation manners and application scope according to the idea of the present invention. In conclusion, the content of this specification should not be construed as a limitation to the present invention.

What is claimed is:

1. A chip control method, wherein the chip provides n voltage ranks, n is a natural number larger than or equal to 2, a working temperature of the chip is divided into at least two temperature ranges, and the method comprises:
acquiring a required frequency of the chip;
detecting a current temperature of the chip, and determining a temperature range [Tₘ, Tₘ₊₁] to which the current temperature belongs, wherein T indicates a temperature, and m is a natural number;
determining, through comparison according to ascending order of sorting the n voltage ranks, whether a frequency at which the chip can work at each temperature point of an analytical temperature range in an i^{th} voltage rank is higher than the required frequency, wherein the analytical temperature range has a margin δ relative to the temperature range [Tₘ, Tₘ₊₁], δ≧0, and i=0, 1, . . . , n−1; and
if yes, using the i^{th} voltage rank as a working voltage of the chip, and using the required frequency as a working frequency of the chip.

2. The method according to claim 1, wherein the method further comprises:
if the frequency at which the chip can work at each temperature point of the analytical temperature range in the i^{th} voltage rank is lower than the required frequency, determining, through comparison, whether a frequency at which the chip can work at each temperature point of the analytical temperature range in an (i+1)^{th} voltage rank is higher than the required frequency.

3. The method according to claim 2, wherein the method further comprises:
if all frequencies at which the chip can work at each temperature point of the analytical temperature range in the n voltage ranks are lower than the required frequency, using a highest voltage rank among the n voltage ranks as a working voltage of the chip, and using a frequency at which the chip can work at each temperature point of the analytical temperature range in the highest voltage rank as a working frequency of the chip.

4. The method according to claim 1, wherein the method further comprises:
detecting whether the current temperature of the chip rises to another temperature range [Tₘ₊₁, Tₘ₊₂], and if yes, determining, through comparison according to the ascending order of sorting the n voltage ranks, whether a frequency at which the chip can work at each temperature point of another analytical temperature range in the i^{th} voltage rank is higher than the required frequency, wherein the another analytical temperature range has a margin δ relative to the another temperature range [Tₘ₊₁, Tₘ₊₂].

5. The method according to claim 4, wherein the method further comprises:
using the i^{th} voltage rank as the working voltage of the chip and using the required frequency as the working frequency of the chip if it is determined, through comparison according to the ascending order of sorting the n voltage ranks, that the frequency at which the chip can work at each temperature point of the another analytical temperature range in the i^{th} voltage rank is higher than the required frequency.

6. The method according to claim 4, wherein the method further comprises:
using the highest voltage rank among the n voltage ranks as the working voltage of the chip, and using a frequency at which the chip can work at each temperature point of the another analytical temperature range in the highest voltage rank as the working frequency of the chip if all frequencies at which the chip can work at each temperature point of the another analytical temperature range in the n voltage ranks are lower than the required frequency.

7. The method according to claim 1, wherein the method further comprises:
detecting whether the current temperature of the chip drops to another temperature range [Tₘ₋₁, Tₘ], and if yes, determining, through comparison according to the ascending order of sorting the n voltage ranks, whether a frequency at which the chip can work at each temperature point of another analytical temperature range in the i^{th} voltage rank is higher than the required frequency, wherein the another analytical temperature range has a margin δ relative to the another temperature range [Tₘ₋₁, Tₘ].

8. The method according to claim 7, wherein the method further comprises:
using the i^{th} voltage rank as the working voltage of the chip and using the required frequency as the working frequency of the chip if it is determined, through comparison according to the ascending order of sorting the n voltage ranks, that the frequency at which the chip can work at each temperature point of the another analytical temperature range in the i^{th} voltage rank is higher than the required frequency.

9. The method according to claim 7, wherein the method further comprises:
using the highest voltage rank among the n voltage ranks as the working voltage of the chip, and using a frequency at which the chip can work at each temperature point of the another analytical temperature range in the highest voltage rank as the working frequency of the chip if all frequencies at which the chip can work at each temperature point of the another analytical temperature range in the n voltage ranks are lower than the required frequency.

10. The method according to claim 1, wherein the acquiring a required frequency of the chip comprises:
acquiring a required frequency that is internally generated by the chip; or
acquiring a required frequency that is input by a pin of the chip.

11. A chip control device, wherein a chip that is controlled by the chip control device provides n voltage ranks, n is a natural number larger than or equal to 2, a working temperature of the chip is divided into at least two temperature ranges, and the chip control device comprises:
an acquiring unit, configured to acquire a required frequency of the chip;
a detecting unit, configured to detect a current temperature of the chip, and determine a temperature range [Tₘ, Tₘ₊₁] to which the current temperature belongs, wherein T indicates a temperature, and m is a natural number;
a comparing unit, configured to determine, through comparison according to ascending order of sorting the n voltage ranks, whether a frequency at which the chip can work at each temperature point of an analytical temperature range in an i^{th} voltage rank is higher than the required frequency, wherein the analytical temperature range has a margin δ relative to the temperature range [Tₘ, Tₘ₊₁], δ≧0, and i=0, 1, . . . , n−1; and
an updating unit, configured to use the i^{th} voltage rank as a working voltage of the chip and use the required frequency as a working frequency of the chip when a comparison result of the comparing unit is yes.

12. The device according to claim 11, wherein if the comparing unit determines, through comparison, that the frequency at which the chip can work at each temperature point of the analytical temperature range in the i^{th} voltage rank is lower than the required frequency,
the comparing unit is further configured to determine, through comparison, whether a frequency at which the chip can work at each temperature point of the analytical temperature range in an (i+1)^{th} voltage rank is higher than the required frequency.

13. The device according to claim 12, wherein if the comparing unit determines, through comparison, that all frequencies at which the chip can work at each temperature point of the analytical temperature range in the n voltage ranks are lower than the required frequency,
the updating unit is further configured to use a highest voltage rank among the n voltage ranks as a working voltage of the chip, and use a frequency at which the chip can work at each temperature point of the analytical temperature range in the highest voltage rank as a working frequency of the chip.

14. The device according to claim 11, wherein:
the detecting unit is further configured to detect whether the current temperature of the chip rises to another temperature range [Tₘ₊₁, Tₘ₊₂]; and
the comparing unit is further configured to, when the detecting unit has detected that the current temperature of the chip rises to the another temperature range [Tₘ₊₁, Tₘ₊₂], determine, through comparison according to the ascending order of sorting the n voltage ranks, whether a frequency at which the chip can work at each temperature point of another analytical temperature range in the i^{th} voltage rank is higher than the required frequency, wherein the another analytical temperature range has a margin δ relative to the another temperature range [Tₘ₊₁, Tₘ₊₂].

15. The device according to claim 14, wherein if the comparing unit determines, through comparison, that all frequencies at which the chip can work at each temperature point of the another analytical temperature range in the n voltage ranks are lower than the required frequency,
the updating unit is further configured to use the highest voltage rank among the n voltage ranks as the working voltage of the chip, and use a frequency at which the chip can work at each temperature point of the another analytical temperature range in the highest voltage rank as the working frequency of the chip.

16. The device according to claim 11, wherein:
the detecting unit is further configured to detect whether the current temperature of the chip drops to another temperature range [Tₘ₋₁, Tₘ] and
the comparing unit is further configured to, when the detecting unit has detected that the current temperature of the chip drops to the another temperature range [Tₘ₋₁, Tₘ], determine, through comparison according to the ascending order of sorting the n voltage ranks, whether a frequency at which the chip can work at each temperature point of another analytical temperature range in the i^{th} voltage rank is higher than the required frequency, wherein the another analytical temperature range has a margin δ relative to the another temperature range [Tₘ₋₁, Tₘ].

17. The device according to claim 16, wherein if the comparing unit determines, through comparison, that all frequencies at which the chip can work at each temperature point of the another analytical temperature range in the n voltage ranks are lower than the required frequency,
the updating unit is further configured to use the highest voltage rank among the n voltage ranks as the working voltage of the chip, and use a frequency at which the chip can work at each temperature point of the another analytical temperature range in the highest voltage rank as the working frequency of the chip.

18. The device according to claim 11, wherein the acquiring unit is specifically configured to acquire a required frequency that is internally generated by the chip, or configured to acquire a required frequency that is input by a pin of the chip.
